(19) United States
(12) Patent Application Publication
(10) Pub. No.: US 2006/0111138 A1
(43) Pub. Date: May 25, 2006

(54) Wireless communication circuit, wireless communication circuit system, and wireless communication apparatus

(76) Inventor: Kazutoshi Satou, Nagaokakyo-shi (JP)

Correspondence Address: STEVENS, DAVIS, MILLER & MOSHER, LLP, 1615 L. STREET N.W., SUITE 850, WASHINGTON, DC, 20036, US

(21) Appl. No.: 11/210,664

(22) Filed: Aug. 25, 2005

(30) Foreign Application Priority Data
Aug. 27, 2004 (JP) 2004-249108

(51) Int. Cl. H04M 1/00

(52) U.S. Cl. 455/550.1; 455/73

(57) ABSTRACT

A first switch is provided between a received signal detector circuit and an amplifier circuit of a microphone signal, and a high pass filter, and a second switch is provided between a high pass filter, and a signal amplifier circuit in a preceding stage of a loudspeaker and an amplitude limiting circuit of a transmission signal. The high pass filter is thereby shared for transmission and reception. The high pass filter filters a tone signal from an output signal of the received signal detector circuit to extract an audio signal in reception. The high pass filter also filters a frequency component of the tone signal included in the audio signal inputted from the microphone in transmission.

### BACKGROUND OF THE INVENTION

1. Field of the Invention

The present inventions relates generally to a wireless communication apparatus, such as a transceiver provided with a tone signal generating function and a frequency discriminating function of the tone signal, and a wireless communication circuit and a wireless communication circuit system composing the same, and particularly to a method of reducing the number of parts.

2. Description of the Prior Art

As a prior art of a wireless communication apparatus, such as a transceiver provided with a tone signal generating function and a frequency discriminating function of the tone signal, a configuration described in, for example patent document 1 will be included as an example.

FIG. 4 is a block diagram showing a configuration of a wireless communication apparatus according to the prior art.

In FIG. 4, reference numeral 1 represents an antenna; reference numeral 2, an antenna switching circuit for switching between a reception signal and a transmission signal; reference numeral 3, a receiving channel selection circuit for passing a received signal to a subsequent stage when the receive signal is a preset frequency; reference numeral 4, an amplifier circuit for amplifying the received signal; reference numeral 5, a received signal detector circuit such as an FM demodulation or the like for demodulating the received signal; reference numeral 6, a tone frequency discrimination circuit for discriminating a frequency of the tone signal included in the received signal; reference numeral 7, an audio signal processing circuit for processing an audio signal included in the received signal; reference numeral 8, a loudspeaker; reference numeral 9, a microphone; reference numeral 10, a transmission modulation circuit; reference numeral 11, a tone generating circuit for generating the tone signal to be included in the transmission signal; reference numeral 12, a transmission power amplifier circuit; and reference numeral 13, a controller for serving a communication control of the circuit.

The tone frequency discrimination circuit 6 is composed of a low pass filter 14 for filtering the audio signal, and a comparator 15 for waveshaping an output signal of the low pass filter 14 into a pulse signal.

The audio signal processing circuit 7 is composed of a high pass filter 16 for filtering the tone signal, and an amplifier circuit 17 for amplifying a signal to the loudspeaker 8.

The transmission modulation circuit 10 is composed of an amplifier circuit 18 for amplifying a feeble output signal from the microphone 9, a high pass filter 19 for filtering a frequency component of the tone signal inputted from the microphone 9, an amplitude limiting circuit 20 for limiting the maximum modulation factor in transmission, an adding circuit 21 for mixing the audio signal and the tone signal, a low pass filter 22 for restricting a frequency band of the transmission signal, and a voltage controlled oscillator (VCO) 23 for FM modulating the transmission signal.

Next, processing of the tone signal and the audio signal in the wireless communication apparatus will be explained. Typically, a frequency band of 67 Hz to 250 Hz is used as the tone signal, and the tone signal is transmitted and received together with the audio signal with a frequency band of 300 Hz to 3 kHz.

When many frequency components of the tone signal are included in the audio signal outputted from the microphone 9, it becomes hard to discriminate the frequency of the tone signal at a receiving side. For that reason, a frequency characteristic 30 for significantly attenuating the frequency band of the tone signal as shown in FIG. 5 is given to the high pass filter 19 in the transmission modulation circuit 10.

Meanwhile, at the receiving side, in order to filter the audio signal in the tone frequency discrimination circuit 6, a frequency characteristic 31 for significantly attenuating the frequency band of the audio signal as shown in FIG. 5 is given to the low pass filter 14.

In addition, as for the audio signal to be transmitted to the loudspeaker 8, the frequency characteristic 30 for significantly attenuating the frequency component of the tone signal is given to the high pass filter 16 so that the tone signal may not be heard from the loudspeaker 8.

Typically, a cut-off frequency f1 of the high pass filters 16 and 19 is set near 300 Hz, and a cut-off frequency f2 of the low pass filter 14 is set near 250 Hz.

Each of above filters is usually composed of five or more stages. For example, the high pass filter is achieved by a circuit configuration as shown in FIG. 6. In FIG. 6, each of reference numerals 35 through 39 represents a resistor; each of reference numerals 40 through 46, a capacitor; each of reference numerals 47 and 48, an operational amplifier; each of reference numerals 49 through 51, a ground; each of reference numerals 52 and 53, a reference voltage; reference numeral 54, an input terminal; and reference numeral 55, an output terminal.

Next, referring now to FIG. 7, a specific example of the tone generating circuit 11 in FIG. 4 will be explained. In FIG. 7, reference numeral 13 represents the controller; each of reference numerals 60 through 65, a resistor; reference numeral 66, a ground; reference numeral 67, an output terminal; and each of reference numerals 68 through 70, a terminal for outputting a pulse signal.

The tone generating circuit 11 shown in FIG. 7 is composed of a typical 3-bit D/A converter. This tone generating circuit 11 properly controls the pulse signal outputted from the terminals 68 through 70 of the controller 13 to output the tone signal close to a sine wave as shown in FIG. 8 from the output terminal 67.

Patent documents 1: Japanese Laid-open Patent Application Publication No. H6-350477

The high pass filter shown in FIG. 6, however, requires a large number of parts. Further, when the tone generating circuit 11 shown in FIG. 7 has been used, there has been a problem that the number of terminals of the controller 13 has been increased.

### SUMMARY OF THE INVENTION

It is therefore an object of the present invention to provide a wireless communication circuit, a wireless communication circuit system, and a wireless communication apparatus, in which the number of parts can be reduced.

It is another object of the present invention to provide the wireless communication circuit system and the wireless communication apparatus, in which the number of terminals of a controller can be reduced.

In order to solve the problem described above, a wireless communication circuit according to the present invention includes a received signal detector circuit whose output signal includes a tone signal, a microphone for outputting an audio signal, a high pass filter for filtering the tone signal, first switching means of selectively forming a first signal path in which a high pass filter is arranged in a subsequent stage of the received signal detector circuit and a second signal path in which the high pass filter is arranged in a subsequent stage of the microphone.

When the first switching means selectively forms the first signal path, the output signal of the received signal detector circuit is passed through the high pass filter, and the high pass filter thereby filters the tone signal from the output signal of the received signal detector circuit to extract the audio signal. Meanwhile, when the first switching means selectively forms the second signal path, the audio signal outputted from the microphone is passed through the high pass filter, and the high pass filter thereby filters a frequency component of the tone signal from the audio signal outputted from the microphone.

Specifically, the switches are arranged between the received signal detector circuit and the amplifier circuit of the microphone signal, and the high pass filter, and between the high pass filter, and the signal amplifier circuit in a preceding stage of the loudspeaker and the amplitude limiting circuits of the transmission signal, respectively, so that the high pass filter can be shared for transmission and reception.

According to this configuration, one high pass filter can be shared for filtering the tone signal included in the output signal of the received signal detector circuit, and filtering the frequency component of the tone signal included in the audio signal inputted from the microphone. As a result, one high pass filter can be eliminated, thereby making it possible to achieve a reduction of the number of parts.

The wireless communication circuit system according to the present invention includes the wireless communication circuit described above, and a controller for communication control, which controls this wireless communication circuit.

The wireless communication apparatus according to the present invention includes the wireless communication circuit system described above.

Preferably, the wireless communication circuit system and the wireless communication apparatus described above may include the low pass filter for filtering the audio signal, and second switching means of selectively forming the first signal path in which the low pass filter is used for the frequency discrimination of the tone signal included in the output signal of the received signal detector circuit and the second signal path in which the low pass filter is used for the generation of the tone signal included in the transmission signal, respectively.

According to this configuration, when the second switching means selectively forms the first signal path, the output signal of the received signal detector circuit is passed through the low pass filter, and the low pass filter thereby extracts the tone signal from the output signal of the received signal detector circuit in order to discriminate the frequency of the tone signal. Meanwhile, when the second switching means selectively forms the second signal path, a pulse signal is outputted from the controller to be passed through the low pass filter, and the low pass filter thereby filters a higher harmonic from the pulse signal to generate the tone signal.

Specifically, the pulse signal with the same frequency as that of the tone signal desired to be outputted is outputted from the controller, and the switches are provided anterior and posterior the low pass filter of the subsequent stage of the received signal detector circuit, respectively, so that the pulse signal is inputted into the low pass filter in transmission, thereby allowing to generate the tone signal close to a sine wave.

According to this configuration, the low pass filter used for the frequency discrimination of the tone signal included in the output signal of the received signal detector circuit is utilized, and the pulse signal outputted from the controller is passed through the low pass filter, so that the higher harmonic is filtered from the pulse signal, allowing to generate the tone signal. For that reason, what is necessary is to output the pulse signal having the same fundamental frequency as that of the tone signal from the controller. Accordingly, that makes it possible to achieve a reduction of the number of terminals of the controller and an elimination of the number of resistors that are required for the tone signal generation.

As described above, according to the present invention, one high pass filter can be eliminated, and the reduction of the number of terminals of the controller and the elimination of the number of the resistors that are required for tone signal generation can be achieved, thereby making it possible to easily achieve a cost reduction and a miniaturization of the wireless communication apparatus.

### BRIEF DESCRIPTION OF THE DRAWINGS

FIG. 1 is a block diagram showing a circuit configuration of a wireless communication apparatus according to a first embodiment of the present invention;

FIG. 2 is a block diagram showing a circuit configuration of a wireless communication apparatus according to a second embodiment of the present invention;

FIG. 3 is a waveform chart showing a signal waveform of a tone signal generating circuit of the wireless communication apparatus according to the second embodiment of the present invention;

FIG. 4 is a block diagram showing a circuit configuration of a wireless communication apparatus according to the prior art;

FIG. 5 is a characteristic graph showing a frequency characteristics of a low pass filter and a high pass filter used for the wireless communication apparatus;

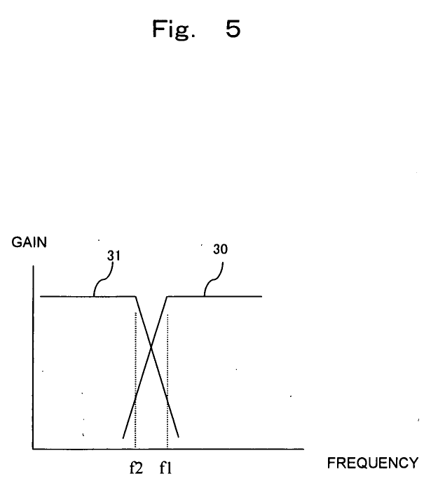

FIG. 6 is a circuit diagram showing a specific example of the high pass filter used for the wireless communication apparatus;

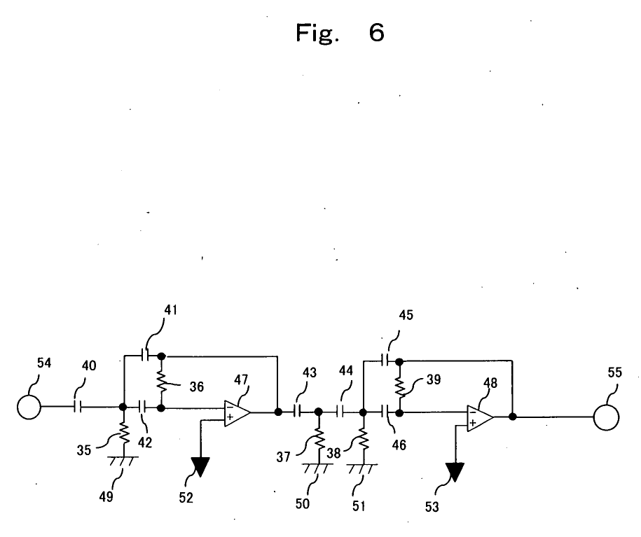

FIG. 7 is a circuit diagram showing a specific example of the tone signal generating circuit used for the wireless communication apparatus according to the prior art; and

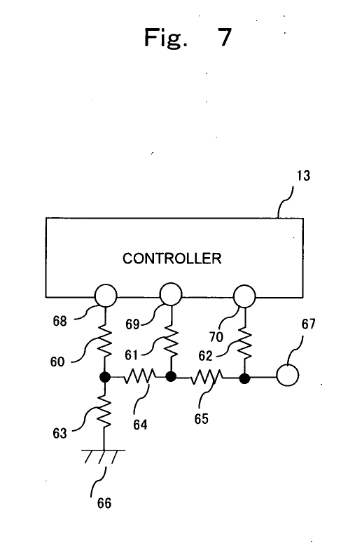

FIG. 8 is a waveform chart showing a signal waveform of the tone signal generating circuit used for the wireless communication apparatus according to the prior art.

### DETAILED DESCRIPTION OF THE PREFERRED EMBODIMENTS

Hereafter, referring to the drawings, embodiments of the present invention will be explained.

### First Embodiment

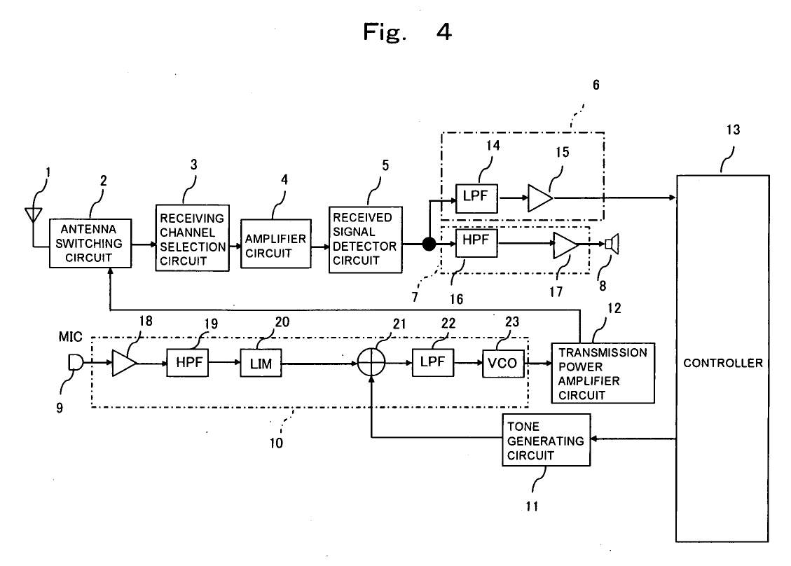

Hereinafter, referring to the drawings, a wireless communication apparatus according to a first embodiment of the present invention will be explained. The same symbol is given to a member corresponding to the member explained in FIG. 4, and detailed description will be omitted.

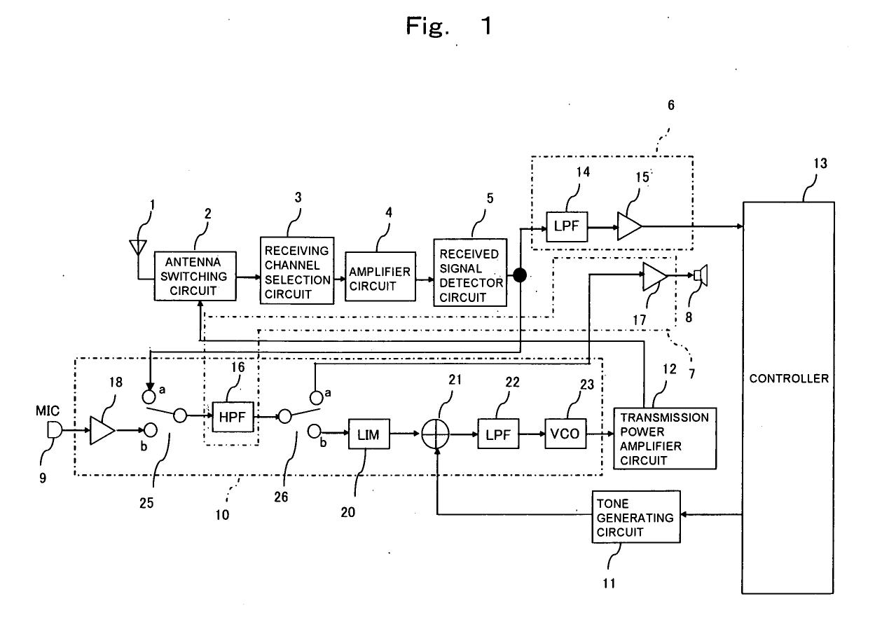

FIG. 1 shows a circuit configuration of the wireless communication apparatus for explaining the first embodiment of the present invention. In FIG. 1, reference numeral 1 represents an antenna; reference numeral 2, an antenna switching circuit for switching a reception signal and a transmission signal; reference numeral 3, a receiving channel selection circuit for passing a received signal to a subsequent stage when the received signal is a preset frequency; reference numeral 4, an amplifier circuit for amplifying the received signal; reference numeral 5, a received signal detector circuit such as an FM demodulation or the like for demodulating the received signal; reference numeral 6, a tone frequency discrimination circuit for discriminating a frequency of the tone signal included in the received signal; reference numeral 7, an audio signal processing circuit for processing an audio signal included in the received signal; reference numeral 8, a loudspeaker; reference numeral 9, a microphone; reference numeral 10, a transmission modulation circuit; reference numeral 11, a tone generating circuit for generating the tone signal to be included in the transmission signal; reference numeral 12, a transmission power amplifier circuit; and reference numeral 13, a controller for serving a communication control of the circuit.

The tone frequency discrimination circuit 6 is composed of a low pass filter 14 for filtering the audio signal, and a comparator 15 for waveshaping an output signal of the low pass filter 14 into a pulse signal.

The audio signal processing circuit 7 is composed of a high pass filter 16 for filtering the tone signal, and an amplifier circuit 17 for amplifying a signal to the loudspeaker 8.

The transmission modulation circuit 10 is composed of an amplifier circuit 18 for amplifying a feeble output signal from the microphone 9, a high pass filter 19 for filtering a frequency component of the tone signal inputted from the microphone 9, an amplitude limiting circuit 20 for limiting the maximum modulation factor in transmission, an adding circuit 21 for mixing the audio signal and the tone signal, a low pass filter 22 for restricting a frequency band of the transmission signal, and a voltage controlled oscillator (VCO) 23 for FM modulating the transmission signal.

The controller 13 operates the audio signal processing circuit 7 of a receiving circuit based on the output of the tone frequency discrimination circuit 6 when the tone frequency included in the received signal is matched to a frequency being preset by itself, allowing the communication with a partner. Moreover, the controller 13 provides the digital signal for generating the tone signal with the preset frequency to the tone generating circuit 11.

Furthermore, the controller 13 controls a switching between a transmission and a reception, a switching between transmission and reception frequencies, or the like.

When the tone signal is used, communication may be allowed only between the wireless communication apparatuses whose transmission and reception frequencies (for example, 450 MHz band) and preset frequencies of the tone signal are mutually matched. For that reason, the tone signal is used in order to reduce a radio interference with other wireless communication apparatus with the same transmission and reception frequencies.

Reference numeral 25 represents a switch for selecting whether the audio signal inputted from the microphone 9 is inputted into the high pass filter 16, or the output signal of the received signal detector circuit 5 is inputted into the high pass filter 16. Reference numeral 26 represents a switch for selecting whether the output signal of the high pass filter 16 is transmitted to the loudspeaker 8, or to the amplitude limiting circuit 20 of the transmission signal. The switching of the switches 25 and 26 is performed by the controller 13 in synchronizing with a switching between transmission and reception.

In the wireless communication apparatus, both switches 25 and 26 are connected to a side of a in reception and to a side of b in transmission, so that the same function as that of the wireless communication apparatus according to the prior art shown in FIG. 4 can be achieved.

A relation among the wireless communication circuit, the wireless communication circuit system, and the wireless communication apparatus will now be explained. A combined circuit including a receiving side circuit composed of the received detector circuit, the tone frequency determination circuit, and the audio signal processing circuit 7, and a transmitting side circuit composed of the microphone, the transmission modulation circuit, and the tone generating circuit is called as the wireless communication circuit. Meanwhile, a combined circuit including the wireless communication circuit and the controller is called as the wireless communication circuit system. Moreover, an entire configuration including the wireless communication circuit system and elements other than that is called as the wireless communication apparatus.

According to the first embodiment, one high pass filter can be eliminated, thereby making it possible to easily achieve the cost reduction and the miniaturization of the wireless communication apparatus.

### Second Embodiment

Hereinafter, referring to the drawings, a wireless communication apparatus according to a second embodiment of the present invention will be explained. The same symbol is given to a member corresponding to the member explained in FIGS. 1 and 4, and detailed description will be omitted.

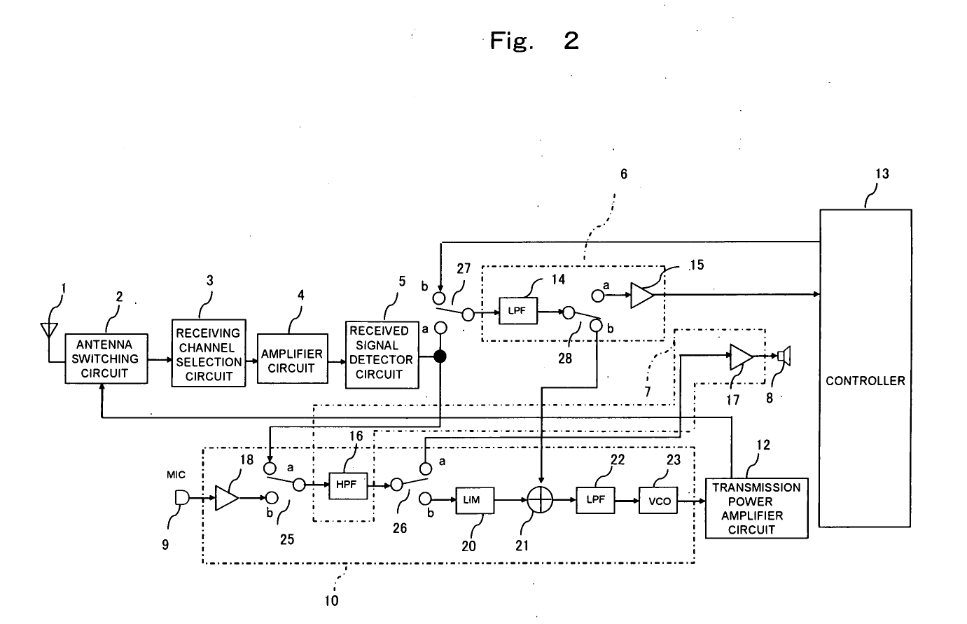

FIG. 2 shows a circuit configuration of the wireless communication apparatus for explaining the second embodiment of the present invention. In FIG. 2, reference numeral 27 represents a switch for selecting whether the pulse signal outputted from the controller 13 is inputted into the low pass filter 14, or the output signal of the received signal detector circuit 5 is inputted into the low pass filter 14. Reference numeral 28 represents a switch for selecting whether the output signal of the low pass filter 14 is transmitted to the comparator 15, or to the adding circuit 21.

According to this embodiment, the tone generating circuit 11 composed of the resistors as shown in the prior art is not required. The low pass filter 14 serves as the tone generating circuit.

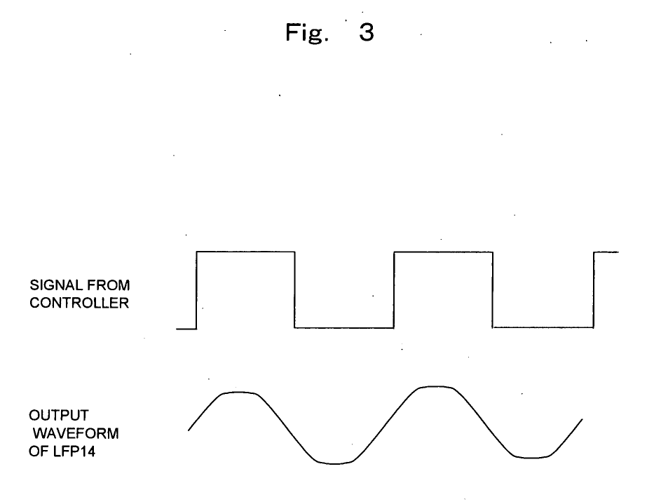

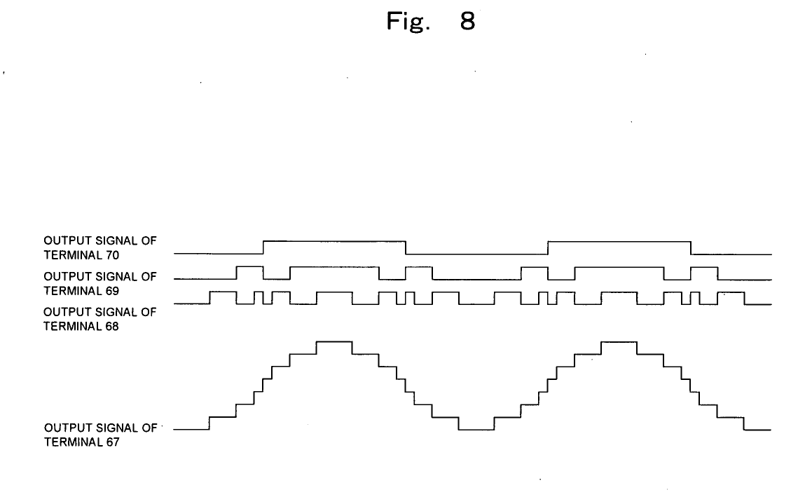

Next, referring to FIG. 3, a configuration of the tone generating circuit in FIG. 2 will be explained. In transmission, the pulse signal with the same frequency as that of the tone signal desired to be achieved is outputted from the controller 13, and the switches 27 and 28 are connected to the side of b, so that the pulse signal is inputted into the low pass filter 14. Since a harmonic content of the pulse signal is filtered by doing it in such a way, the signal outputted from the low pass filter 14 is turned into a signal close to a sine wave equivalent to the tone signal achieved by the configuration of the prior art as shown in FIG. 8. The signal outputted from the low pass filter 14 is inputted into the adding circuit 21 instead of the output of the tone generating circuit 11.

In reception, the same function as that of the wireless communication apparatus according to the prior art shown in FIG. 4 can be achieved by connecting the switches 27 and 28 to the side of a.

According to the second embodiment, the number of the pulse output terminals of the controller 13, in which three or more pulse output terminals have been conventionally required, can be reduced to one and the resistor can also be reduced, thereby making it possible to easily achieve the cost reduction and the miniaturization of the wireless communication apparatus.

### INDUSTRIAL AVAILABILITY

As described above, the present invention is available in carrying out the cost reduction and the miniaturization of the wireless communication apparatus.

What is claimed is:

1. A wireless communication circuit comprising:
a received signal detector circuit whose output signal includes a tone signal; a microphone for outputting an audio signal; a high pass filter for filtering said tone signal; and first switching means of selectively forming a first signal path in which said high pass filter is arranged in a subsequent stage of said received signal detector circuit and a second signal path in which said high pass filter is arranged in a subsequent stage of said microphone,
wherein when said first switching means selectively forms siad first signal path, the output signal of said received signal detector circuit is passed through said high pass filter, and said high pass filter thereby filters said tone signal from the output signal of said received signal detector circuit to extract the audio signal,
wherein when said first switching means selectively forms said second signal path, the audio signal outputted from said microphone is passed through said high pass filter, and said high pass filter thereby filters a frequency component of the tone signal from said audio signal outputted from said microphone.

2. A wireless communication circuit system comprising: the wireless communication circuit according to claim 1; and a controller for communication control, which controls said wireless communication circuit.

3. A wireless communication apparatus comprising the wireless communication circuit system according to claim 2.

4. The wireless communication circuit system according to claim 2, further comprising:
a low pass filter for filtering said audio signal; and second switching means of selectively forming a first signal path in which said low pass filter is used for a frequency discrimination of the tone signal included in the output signal of said received signal detector circuit, and a second signal path in which said low pass filter is used for a generation of the tone signal to be included in a transmission signal,
wherein when said second switching means selectively forms said first signal path, the output signal of said received signal detector circuit is passed through said low pass filter, and said low pass filter thereby extracts said tone signal from the output signal of said received signal detector circuit in order to discriminate the frequency of said tone signal,
wherein when said second switching means selectively forms said second signal path, a pulse signal is outputted from said controller to be passed through said low pass filter, and said low pass filter thereby filters a higher harmonic from said pulse signal to generate the tone signal.

5. The wireless communication apparatus according to claim 3, further comprising:
a low pass filter for filtering said audio signal to extract a frequency component of said tone signal; and a second switching means of selectively forming a first signal path in which said low pass filter is used for a frequency discrimination of the tone signal included in the output signal of said received signal detector circuit, and a second signal path in which said low pass filter is used for a generation of the tone signal to be included in a transmission signal,
wherein when said second switching means selectively forms said first signal path, the output signal of said received signal detector circuit is passed through said low pass filter, and a frequency of said tone signal is thereby discriminated,
wherein when said second switching means selectively forms said second signal path, a pulse signal is outputted from said controller to be passed through said low pass filter, and a higher harmonic is thereby filtered from said pulse signal for the tone signal to be generated.
